(19) United States
(12) Patent Application Publication
(10) Pub. No.: US 2015/0234771 A1
(43) Pub. Date: Aug. 20, 2015

(54) DOCKING STATION OF PORTABLE ELECTRONIC DEVICE AND SAFE REMOVING METHOD THEREOF

(71) Applicant: ACER INCORPORATED, New Taipei City (TW)

(72) Inventor: Po-Wei Wu, New Taipei City (TW)

(21) Appl. No.: 14/601,200

(22) Filed: Jan. 20, 2015

(30) Foreign Application Priority Data
Feb. 20, 2014 (TW) 103105730

(51) Int. Cl. G06F 13/40; G06F 1/16

(52) U.S. Cl. CPC G06F 13/4081; G06F 1/1632

(57) ABSTRACT

A docking station of a portable electronic device and a safely plugging method thereof are provided. The portable electronic device is removably connected to the docking station, so as to perform data accessing to a storage device in the docking station. The method includes: detecting a removing signal; reading an accessing state of the storage device in response to the removing signal; when the accessing state of the storage device is not a idle state, making the portable electronic device to be in an unremovable state; and when the accessing state of the storage device is the idle state, making the portable electronic device to be in a removable state.

### CROSS-REFERENCE TO RELATED APPLICATION

This application claims the priority benefit of Taiwan application serial no. 103105730, filed on Feb. 20, 2014. The entirety of the above-mentioned patent application is hereby incorporated by reference herein and made a part of this specification.

### BACKGROUND

1. Technical Field

The invention relates to a docking station of a portable electronic device. Particularly, the invention relates to a docking station of a portable electronic device and a safe removing method thereof.

2. Related Art

Along with quick development of electronic products, a computer system composed of a tablet personal computer (PC) and a docking station is provided. For example, main circuits (for example, a battery, a main storage device and a processor, etc.) of such computer system are all disposed on the tablet PC, and a secondary storage device, a keyboard and a simple connection circuit are disposed on the docking station. When the tablet PC is not plugged to the docking station, the docking station has no power supply. When the tablet PC is plugged to the docking station by a user, the tablet PC supplies a battery power thereof to the docking station, such that the secondary storage device in the docking station can normally operate. In this way, the tablet PC can perform data accessing to the secondary storage device in the docking station.

However, when the tablet PC sends a command to perform data accessing to the secondary storage device in the docking station, during a process that a data read/write operation is performed to the secondary storage device in the docking station, if the tablet PC is suddenly unplugged by the user, the docking station loses the power supply and instantly stops working, which probably leads to data read/write error or even device damage of the secondary storage device in the docking station.

### SUMMARY

The invention is directed to a docking station of a portable electronic device and a safe removing method thereof, by which a chance of sudden power-off of a storage device in the docking station due to that the portable electronic device is unexpectedly pulled out when the storage device executes a data read/write operation is decreased by sending a notification and/or locking the portable electronic device.

The invention provides a safe removing method of a docking station, which is adapted to a portable electronic device, where the portable electronic device is removably connected to the docking station, so as to perform data accessing to a storage device in the docking station. The method includes following steps. A removing signal is detected. An accessing state of the storage device is read in response to the removing signal. When the accessing state of the storage device is not an idle state, the portable electronic device is made to be in an unremovable state, and when the accessing state of the storage device is the idle state, the portable electronic device is made to be in a removable state.

According to another aspect, the invention provides a docking station of a portable electronic device, where the docking station includes a storage device and a slot. The portable electronic device is removably inserted into the slot, so as to perform data accessing to the storage device in the docking station. The portable electronic device detects a removing signal, and reads an accessing state of the storage device in response to the removing signal. When the accessing state of the storage device is not an idle state, the portable electronic device is made to be in an unremovable state, and when the accessing state of the storage device is the idle state, the portable electronic device is made to be in a removable state.

According to the above descriptions, when the portable electronic device and the docking station are in a connection state, the portable electronic device determines whether the storage device in the docking station is in the idle state (for example, is not executing a data read/write operation) in response to a removing signal, and if yes, the portable electronic device is made to be in the removable state capable of being removed or pulled out at any time; and if not, the portable electronic device is temporarily made to be in the unremovable state that cannot be removed or pulled out until the storage device in the docking station is in the idle state (for example, the data read/write operation is completed), so as to effectively decrease a chance of sudden power-off of the docking station due to that the portable electronic device is unexpectedly pulled out during a process when the storage device in the docking station executes the data read/write operation.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A, FIG. 1B and FIG. 2 are schematic diagrams of a portable electronic device and a docking station thereof according to an exemplary embodiment of the invention.

FIG. 3 is a flowchart illustrating a safe removing method of a docking station according to an exemplary embodiment of the invention.

### DETAILED DESCRIPTION OF DISCLOSED EMBODIMENTS

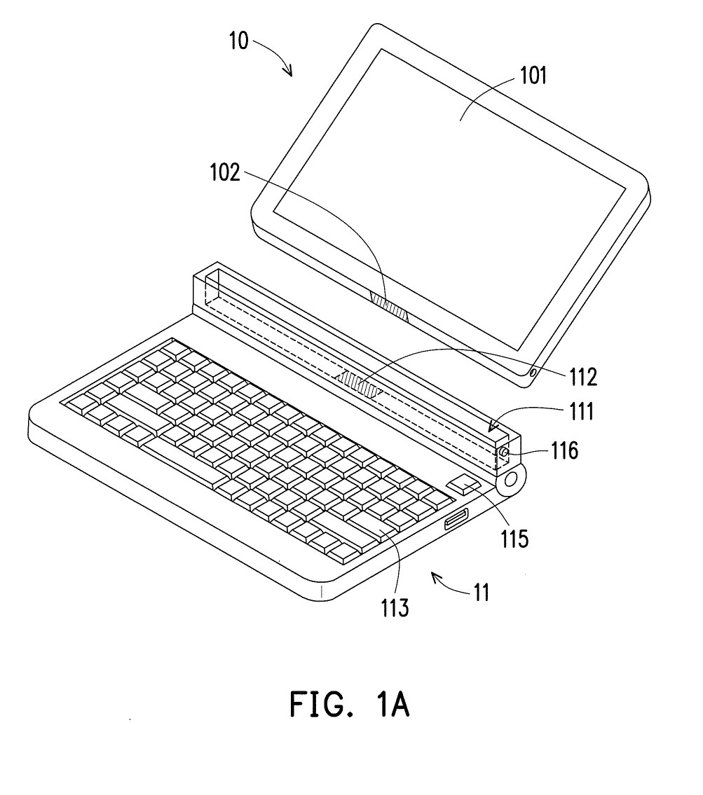

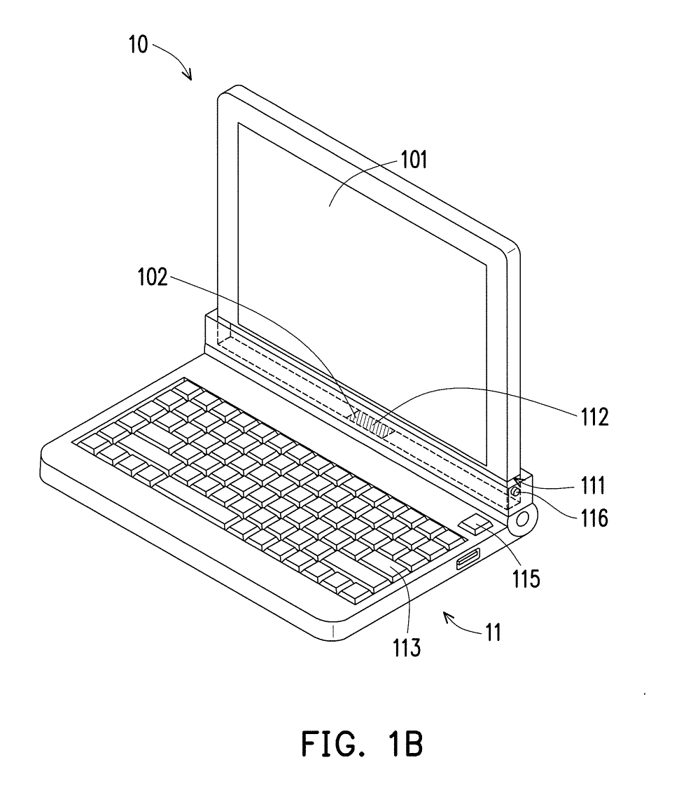

FIG. 1A, FIG. 1B and FIG. 2 are schematic diagrams of a portable electronic device and a docking station thereof according to an exemplary embodiment of the invention.

Referring to FIG. 1A, FIG. 1B and FIG. 2, the portable electronic device 10 is, for example, a tablet personal computer (PC) or a smart phone that at least has a display function and a data processing function.

The portable electronic device 10 has a display device 101, a docking station interface 102, an input device 103, a battery 104, a storage device 105 and a processor 106.

The display device 101 is, for example, display of any type such as a cathode ray tube (CRT) display or a liquid crystal display (LCD), etc., though the invention is not limited thereto.

The docking station interface 102 is used for connecting a docking station 11. The docking station interface 102 is, for example, an advanced host controller interface (AHCI), though the invention is not limited thereto.

The input device 103 includes a touch module and a positioning module, and can be integrated with the display device 101 to form a touch screen. Moreover, the input device 103 may also include a voice input device and physical keys configured to the portable electronic device 10, which is not limited by the invention.

The battery 104 is used for providing a power required by the portable electronic device 10 for normal operation.

The storage device 105 is used for storing data. The storage device 105 may include a hard disk drive (HDD), a volatile memory and a non-volatile memory, which is not limited by the invention.

The processor 106 is used for controlling a whole operation and most of data processing tasks of the portable electronic device 10. For example, when a user inputs an input signal through the input device 103, the processor 106 executes a corresponding operation according to the input signal come from the input device 103, for example, controls the display device 101 to display a specific image and/or perform data accessing to the storage device 105, etc.

The docking station 11 includes a slot 111, a slot interface 112, an input device 113 and a storage device 114.

The slot 111 is used for accepting the portable electronic device 10. As shown in FIG. 1A, a size and a shape of the slot 111 are basically matched to a side edge of the portable electronic device 10 where the docking station interface 102 is located, and the side edge where the docking station interface 102 is located is adapted to be inserted into the slot 111.

The slot interface 112 is used for connecting the portable electronic device 10. The slot interface 112 is disposed opposite to the docking station interface 102. Similar to the docking station interface 102, the slot interface 112 is, for example, an AHCI, though the invention is not limited thereto.

In the present exemplary embodiment, the input device 113 includes a keyboard. Moreover, the input device 113 may further include a touch screen, a touch pad and a voice input device, though the invention is not limited thereto. For example, in another exemplary embodiment, the input device 113 is replaced by a touch screen or a touch pad, which is determined according to an actual application.

The storage device 114 is used for storing data. Similar to the storage device 105, the storage device 114 may include a HDD, a volatile memory and a non-volatile memory, though the invention is not limited thereto.

The portable electronic device 10 can be used alone, or can be used together with the docking station 11 by inserting into the slot 111. Referring to FIG. 1B, since the docking station interface 102 is disposed opposite to the slot interface 112, after the portable electronic device 10 is inserted into the slot 111, the docking station interface 102 is electrically connected to the slot interface 112, and the battery 104 can supply power to the portable electronic device 10 and the docking station 11 simultaneously or according to a specific rule. Meanwhile, the processor 106 can receive an input signal from the input device 113 through the docking station interface 102, and can perform data accessing to the storage device 114, for example, to write data into the storage device 114 or read data from the storage device 114. In other words, after the portable electronic device 10 is connected to the docking station 11, the portable electronic device 10 and the docking station 11 are combined into a coordination platform similar to a notebook computer, where the portable electronic device 10 is similar to a screen of the notebook computer, and is mainly in charge of image output, and the docking station 11 is similar to a base of the notebook computer, and is mainly in charge of signal input. However, if the portable electronic device 10 has a touch function, the touch function can be disabled or enabled, which is not limited by the invention.

It should be noticed that since the docking station 11 does not have a battery or a battery capacity thereof is relatively small, the power required by the docking station 11 for normal operation is mainly supplied by the portable electronic device 10. When the portable electronic device 10 is removed from the docking station 11 (for example, pulled out from the slot 111), the power of the docking station 11 is probably disappeared suddenly or disappeared after a short time. When the power of the docking station 11 is disappeared, if the storage device 114 of the docking station 11 is still executing the data read/write operation, for example, writing data of the portable electronic device 10 into the storage device 114, there is a great chance of data write error or even the hardware equipment is damaged.

Therefore, in an exemplary embodiment, the docking station 11 further includes a switch 115. As shown inn FIG. 1A and FIG. 1B, the switch 115 is, for example, disposed on an upper surface (a surface where the input device 113 is located) of the docking station 11. Alternatively, the switch 115 can also be disposed on a side surface of the docking station 11, which is not limited by the invention. The switch 115 can be a button, a pressure sensor, an infrared sensor or a proximity sensor, etc., and the invention is not limited thereto. When the user wants to remove the portable electronic device 10 from the docking station 11, the user has to first trigger the switch 115 through manners of approaching, touching or pressing, etc., and the switch 115 correspondingly generates a removing signal.

Moreover, in another exemplary embodiment, the user can operate the portable electronic device 10 to generate the removing signal. For example, the user can select a specific object displayed on the display device 101 through the input device 103 or the input device 113 or press a physical button on the portable electronic device 10 to generate the removing signal. Namely, whether the button 115 is configured is determined according to an actual application requirement.

The processor 106 of the portable electronic device 10 detects the removing signal through the docking station interface 102, for example, detects the removing signal through a specific port of the AHCI. Then, in response to the removing signal, the processor 106 reads an accessing state of the storage device 114 in the docking station 11. According to the accessing state of the storage device 114, the processor 106 learns whether the storage device 114 is in an idle state. When the accessing state of the storage device 114 is not the idle state (e.g., non-idle), for example, the storage device 114 is executing the data read/write operation, the processor 106 makes the portable electronic device 10 to be in an unremovable state. Conversely, when the accessing state of the storage device 114 is the idle state, for example, the storage device 114 does not execute the data read/write operation, the processor 106 makes the portable electronic device 10 to be in a removable state, namely, the portable electronic device 10 can be safely pulled out.

In an exemplary embodiment, when the processor 106 determines that the accessing state of the storage device 114 is not the idle state, the processor 106 sends a notification message to notify the user that the storage device 114 is not in the idle state, and not to pull out the portable electronic device 10. Particularly, a method for sending the notification message is to, for example, display a prompt window on the screen of the display device 101, or send the notification message through a voice output. When the user sees or hears the notification message, the user can easily learn that it is not suitable to remove the portably electronic device 10 from the docking station 11 currently.

Moreover, the notification message may include notifying a waiting time required for completing the current data read/write operation of the storage device 114, and the user can learn the timing when the portable electronic device 10 is suitable for being pulled out according to the notification message. Moreover, after the data read/write operation of the storage device 114 is completed, the processor 106 can also notify the user that the portable electronic device 10 can be now removed from the docking station 11 safely through another notification message.

However, in another exemplary embodiment, when the processor 106 determines that the accessing state of the storage device 114 is not the idle state, for example, the storage device 114 is executing the data read/write operation, the processor 106 can force the storage device 114 to stop the currently-executed data read/write operation. In this way, the user can immediately remove the portable electronic device 10 from the docking station 11 without waiting or after a very short time of waiting.

Moreover, in an exemplary embodiment, the notification message may include notifying the user to select to force the storage device 114 to stop the data read/write operation or select to wait for completion of the data read/write operation of the storage device 114. For example, the user can execute a selection operation through the input device 103 or the input device 113. The processor 106 receives the selection operation, and determines whether to force the storage device 114 to stop the data read/write operation or wait for completion of the data read/write operation of the storage device 114 according to the selection operation. For example, if the user selects to force the storage device 114 to stop the data read/write operation, the processor 106 directly forces the storage device 114 to stop the currently-executed data read/write operation. Comparatively, if the user selects to wait for completion of the data read/write operation, the processor 106 wait for completion of the data read/write operation of the storage device 114, and the processor 106 may notify a waiting time required for completing the current data read/write operation of the storage device 114, and/or after the data read/write operation of the storage device 114 is completed, the processor 106 can also notify the user that the portable electronic device 10 can be now removed from the docking station 11 safely through another notification message.

However, the invention is not limited to the aforementioned implementations. In an exemplary embodiment, the docking station 110 further includes a tenon 116. The tenon 116 is coupled to the slot interface 112 and is, for example, disposed in the slot 111 of the docking station 11. The tenon 116 can be controlled by the processor 106. When the portable electronic device 10 is inserted into the slot 111 of the docking station 11 to reach a certain position (for example, the docking station interface 102 and the slot interface 112 are contacted), the tenon 116 is adapted to lock the portable electronic device 10, and the portable electronic device 10 locked by the tenon 116 cannot be smoothly pulled out.

In the present exemplary embodiment, the processor 106 also reads the accessing state of the storage device 114 in response to the removing signal. When the processor 106 determines that the accessing state of the storage device 114 is not the idle state, for example, the storage device 114 is executing the data read/write operation, the processor 106 controls the tenon 116 to maintain a locking state of the portable electronic device 10, and the portable electronic device 10 cannot be smoothly pulled out. Conversely, when the processor 106 determines that the accessing state of the storage device 114 is the idle state, for example, the storage device 114 does not execute the data read/write operation, the processor 106 controls the tenon 116 to release the portable electronic device 10, and the user can pull out the portable electronic device 10 from the slot 111. Namely, when the user triggers the button 115 or operate the portable electronic device 10 to generate the aforementioned removing signal, if the accessing state of the storage device 114 is not the idle state, the portable electronic device 10 is first locked by the tenon 116 and cannot be pulled out, until the processor 106 determines that the accessing state of the storage device 114 is changed to the idle state, the tenon 116 releases the portable electronic device 10, and the user can pull out the portable electronic device 10 from the slot 111.

In this way, before the user removes or pulls out the portable electronic device 10 from the slot 111, as long as the user triggers the button 115 or uses the portable electronic device 10 to generate the removing signal, the portable electronic device 10 can automatically control the tenon 116 according to the accessing state of the storage device 114, so as to avoid a situation that the portable electronic device 10 is pulled out while the storage device 114 is executing the data read/write operation. Moreover, a structure of the tenon 116 and/or an engaging manner between the tenon 116 and the portable electronic device 10 are not limited by the invention as long as the tenon 116 can be controlled by the portable electronic device 10 to lock and release the portable electronic device 10.

Moreover, in another exemplary embodiment, the processor 106 or a similar control circuit can also be disposed in the docking station 11, such that the docking station 11 itself can control the operation of the tenon 116, so as to reduce a working load of the portable electronic device 10, which is determined according to an actual application requirement.

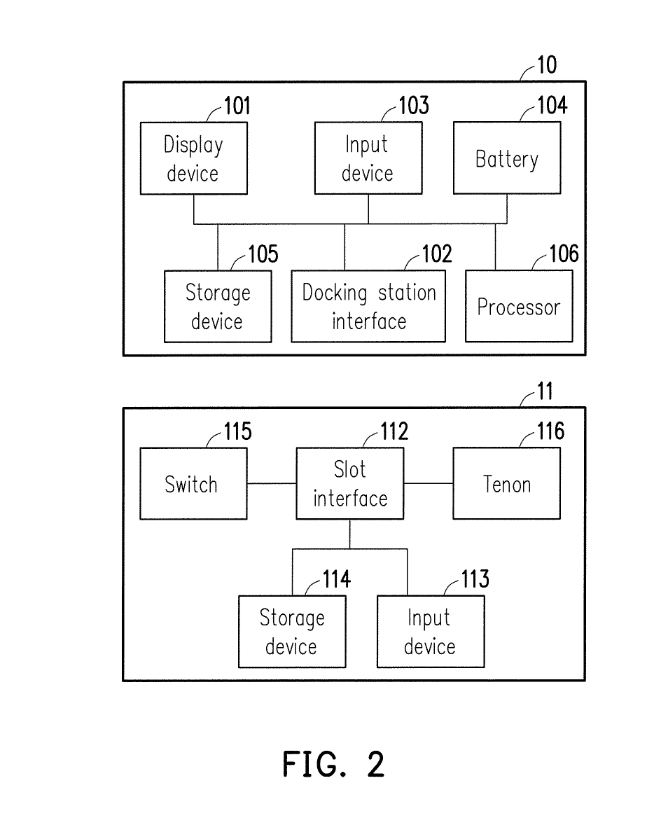

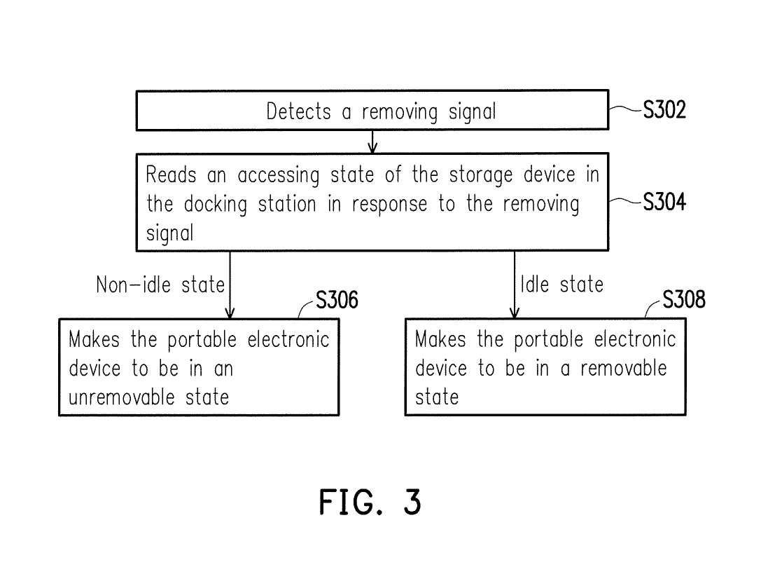

FIG. 3 is a flowchart illustrating a safe removing method of a docking station according to an exemplary embodiment of the invention.

Referring to FIG. 3, in step S302, the processor 106 detects the removing signal through the docking station interface 102. In step S304, the processor 106 reads the accessing state of the storage device 114 in the docking station 11 in response to the removing signal. When the accessing state of the storage device 114 is not the idle state, in step S306, the processor 106 makes the portable electronic device 10 to be in the unremovable state. When the accessing state of the storage device 114 is the idle state, in step S308, the processor 106 makes the portable electronic device 10 to be in the removable state.

In summary, when the portable electronic device and the docking station are in a connection state, the portable electronic device or the docking station itself determines whether the storage device in the docking station is in the idle state (for example, is not executing a data read/write operation) in response to a removing signal, and if yes, the portable electronic device is made to be in the removable state capable of being removed or pulled out at any time; and if not, the portable electronic device is temporarily made to be in the unremovable state that cannot be removed or pulled out until the storage device in the docking station is in the idle state (for example, the data read/write operation is completed), so as to effectively decrease a chance of sudden power-off of the docking station due to that the portable electronic device is unexpectedly pulled out during a process when the storage device in the docking station executes the data read/write operation.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A safe removing method of a docking station, adapted to a portable electronic device, wherein the portable electronic device is removably connected to the docking station, so as to perform data accessing to a storage device in the docking station, the safe removing method of the docking station comprising:
detecting a removing signal;
reading an accessing state of the storage device in response to the removing signal;
making the portable electronic device to be in an unremovable state when the accessing state of the storage device is not an idle state; and
making the portable electronic device to be in a removable state when the accessing state of the storage device is the idle state.

2. The safe removing method of the docking station as claimed in claim 1, wherein the step of making the portable electronic device to be in the unremovable state comprises:
forcing the storage device to stop a data read/write operation.

3. The safe removing method of the docking station as claimed in claim 1, wherein the step of making the portable electronic device to be in the unremovable state when the accessing state of the storage device is not the idle state comprises:
sending a notification message to notify that the accessing state of the storage device is not the idle state; and
receiving a selection operation, and determining to force the storage device to stop a data read/write operation or wait for completion of the data read/write operation according to the selection operation.

4. The safe removing method of the docking station as claimed in claim 1, wherein the portable electronic device is inserted into a slot of the docking station, and the step of making the portable electronic device to be in the unremovable state comprises:
controlling a tenon in the slot to lock the portable electronic device, such that the portable electronic device is unable to be smoothly pulled out from the slot.

5. The safe removing method of the docking station as claimed in claim 4, wherein the step of making the portable electronic device to be in the removable state comprises:
controlling the tenon to release the portable electronic device, such that the portable electronic device is able to be smoothly pulled out from the slot.

6. The safe removing method of the docking station as claimed in claim 1, wherein the removing signal is generated when a switch on the docking station is triggered.

7. A docking station of a portable electronic device, comprising:
a storage device; and
a slot, wherein the portable electronic device is removably inserted in the slot, so as to perform data accessing to the storage device,
wherein the portable electronic device detects a removing signal, and reads an accessing state of the storage device in response to the removing signal,
when the accessing state of the storage device is not an idle state, the portable electronic device is made to be in an unremovable state,
when the accessing state of the storage device is the idle state, the portable electronic device is made to be in a removable state

8. The docking station of the portable electronic device as claimed in claim 7, wherein when the accessing state of the storage device is not the idle state, the storage device is forced to stop a data read/write operation.

9. The docking station of the portable electronic device as claimed in claim 7, wherein the slot has a tenon,
when the accessing state of the storage device is not the idle state, the tenon locks the portable electronic device, such that the portable electronic device is unable to be smoothly pulled out from the slot.

10. The docking station of the portable electronic device as claimed in claim 9, wherein when the accessing state of the storage device is the idle state, the tenon releases the portable electronic device, such that the portable electronic device is able to be smoothly pulled out from the slot.

11. The docking station of the portable electronic device as claimed in claim 7, wherein the docking station further comprises a switch, and the removing signal is generated when the switch is triggered.
